(19) United States
(12) Patent Application Publication
(10) Pub. No.: US 2026/0205981 A1
(43) Pub. Date: Jul. 16, 2026

(54) METHOD PERFORMED BY FIRST CORE NETWORK NODE, METHOD OF USER EQUIPMENT, FIRST CORE NETWORK NODE, AND USER EQUIPMENT

(71) Applicant: NEC Corporation, Tokyo (JP)

(72) Inventors: Prabhu KALIYAMMAL THIRUVASAGAM, Kirchberg (LU); Hiroshi DEMPO, Tokyo (JP); Kengo TAKEBAYASHI, Tokyo (JP)

(73) Assignee: NEC Corporation, Tokyo (JP)

(21) Appl. No.: 19/131,315

(22) PCT Filed: Nov. 28, 2023
(86) PCT No.: PCT/JP2023/042522

§ 371 Date: May 20, 2025

(30) Foreign Application Priority Data
Dec. 2, 2022 (IN) 202211069643

(51) Int. Cl. H04W 60/06; H04W 60/02; H04W 60/04; H04W 74/0833

(52) U.S. Cl. CPC H04W 60/06; H04W 60/02; H04W 60/04; H04W 74/085

(57) ABSTRACT

A method performed by a first core network node in a first core network is provided. The method includes: receiving, from a user equipment (UE), a first message including first information indicating temporary deregistration of the UE from the first core network; transmitting, to the UE, a second message including second information indicating a priority code for registration of the UE to the first core network, wherein the priority code is based on the first information; and receiving, from the UE, a third message for registration, the third message indicating the priority code.

### TECHNICAL FIELD

The present disclosure relates to a method performed by a first core network node, a method of user equipment (UE), a first core network node, and user equipment (UE).

### BACKGROUND ART

The 3^{rd} Generation Partnership Project (3GPP) Service and System Aspects Working Group 2 (SA2) is working to study further enhancements of the 5G System (5GS) to support Non-Public Networks (NPNs). Specifically, the SA2 NPN Study Item aims to address SA1 requirements specified in NPL 1 related to support for Providing Access to Localized Services (PALS). One of the requirements is to provide support for returning to home network, and one of the aspects considered in this requirement is as follows (NPL 2):

Study how to minimize the impact on the UE's communication e.g. to prevent user plane and control plane outages when returning to a home network together with other high number of UEs in a very short period of time, after terminating their temporary local access to a hosting network.

### CITATION LIST

### Non Patent Literature

NPL 1: 3GPP TS 22.261
NPL 2: 3GPP TR 23.700-08
NPL 3: 3GPP TS 23.501
NPL 4: 3GPP TR 21.905
NPL 5: 3GPP TS 23.503
NPL 6: 3GPP TS 23.502
NPL 7: 3GPP TS 23.288
NPL 8: 3GPP TS 24.501
NPL 9: 3GPP TS 33.501
NPL 10: 3GPP TS 38.413
NPL 11: 3GPP TR 22.844
NPL 12: 3GPP TS 23.122
NPL 13: 5G-ACIA White Paper

### SUMMARY OF INVENTION

### Technical Problem

According to the latest specification NPL 3, there are two techniques for controlling congestion at a home network: i) access controlling and barring and ii) control plane load controlling, congestion and overload controlling. However, use of these techniques would increase the overall waiting time for UEs as a random back-off timer value is assigned to a UE indicating how long the UE is to wait before making another attempt due to overload. Also, the same pre-defined range is used to assign a random back-off timer value to all UEs irrespective of their service schedule or priority, and this could increase the waiting time of UEs/users and affect their quality of service and experience.

### Solution to Problem

In a first aspect, the present disclosure provides a method performed by a first core network node in a first core network, the method comprising:
receiving, from a user equipment (UE), a first message including first information indicating temporary deregistration of the UE from the first core network;
transmitting, to the UE, a second message including second information indicating a priority code for registration of the UE to the first core network, wherein the priority code is based on the first information; and
receiving, from the UE, a third message for registration, the third message indicating the priority code.

The third message may indicate re-registration of the UE to the first core network.

The method may further comprise:
generating the priority code based on subscription information for the UE with a second core network node in the first core network.

The method may further comprise:
transmitting, to the UE, a fourth message in response to the third message, the fourth message indicating a rejection for the third message and a backoff time, wherein the backoff time is based on the priority code.

The first message may include an identifier of a second core network to which the UE temporarily registered after the temporary deregistration of the UE from the first core network, and
the priority code may be based on the identifier of the second core network.

The third message may include third information indicating that the UE has returned from the second core network, and
the method may further comprise
determining whether the priority code is valid based on the third information.

The priority code may be indicated with an expiration time of the priority code, and
the method may further comprise
receiving, from the UE, a fifth message for registration, the fifth message not including the priority code in a case where the expiration time is expired.

The first message may be a deregistration request message,
the second message may be deregistration accept message, and
the third message may be registration request message.

The first core network node in the first core network may be an Access and Mobility Management Function (AMF) in a home network, and
the second core network node may be a Unified Data Management (UDM).

In a second aspect, the present disclosure provides a method of a user equipment (UE), the method comprising:
transmitting, to a first core network node in a first core network, a first message including first information indicating temporary deregistration of the UE from the first core network; and
receiving, from the first core network node, a second message including second information indicating a priority code for registration of the UE to the first core network, wherein the priority code is based on the first information.

The method may further comprise
transmitting, to the first core network node, a third message for registration, the third message indicating the priority code.

The third message may indicate re-registration of the UE to the first core network.

The priority code may be generated based on subscription information for the UE with a second core network node in the first core network.

The method may further comprise
receiving, from the first core network, a fourth message in response to the third message, the fourth message indicating a rejection for the third message and a backoff time, wherein the backoff time is generated based on the priority code; and
transmitting, to the first core network node, a fifth message for registration after the backoff time has expired from the receipt of the fourth message.

The first message may include an identifier of a second core network to which the UE temporarily registered after the temporary deregistration of the UE from the first core network, and
the priority code may be based on the identifier of the second core network.

The third message may include third information indicating that the UE has returned from the second core network, and
the priority code may be checked based on the third information.

The priority code may be indicated with an expiration time of the priority code, and
the method may further comprise
transmitting, to the first core network node, a fifth message for registration, the fifth message not including the priority code in a case where the expiration time is expired.

The first message may be a deregistration request message,
the second message may be deregistration accept message, and
the third message may be registration request message.

The first core network node in the first core network may be an Access and Mobility Management Function (AMF) in a home network, and
the second core network node may be a Unified Data Management (UDM).

In a third aspect, the present disclosure provides a first core network node in a first core network, the first core network node comprising:
a memory storing instructions; and
at least one hardware processor configured to process the instructions to:
   receive, from a user equipment (UE), a first message including first information indicating temporary deregistration of the UE from the first core network;
   transmit, to the UE, a second message including second information indicating a priority code for registration of the UE to the first core network, wherein the priority code is based on the first information; and
   receive, from the UE, a third message for registration, the third message indicating the priority code.

In a fourth aspect, the present disclosure provides a user equipment (UE) comprising:
a memory storing instructions; and
at least one hardware processor configured to process the instructions to:
   transmit, to a first core network node in a first core network, a first message including first information indicating temporary deregistration of the UE from the first core network; and
   receive, from the first core network node, a second message including second information indicating a priority code for registration of the UE to the first core network, wherein the priority code is based on the first information.

### BRIEF DESCRIPTION OF DRAWINGS

FIG. 1 shows priority based re-registration procedure.

FIG. 2 shows priority based re-registration procedure between home and hosting network.

FIG. 3 schematically illustrates a telecommunication system for a mobile (cellular or wireless) device (known as a user equipment (UE) to which the above aspects are applicable.

FIG. 4 is a block diagram illustrating the main components of the UE (mobile device).

FIG. 5 is a block diagram illustrating the main components of an exemplary (R)AN node, for example a base station (‘eNB’ in LTE, ‘gNB’ in 5G, a base station for 5G beyond, a base station for 6G).

FIG. 6 schematically illustrates a (R)AN node based on O-RAN architecture to which the (R)AN node aspects are applicable.

FIG. 7 is a block diagram illustrating the main components of an exemplary RU, for example a RU part of base station (‘eNB’ in LTE, ‘gNB’ in 5G, a base station for 5G beyond, a base station for 6G).

FIG. 8 is a block diagram illustrating the main components of an exemplary DU, for example a DU part of a base station (‘eNB’ in LTE, ‘gNB’ in 5G, a base station for 5G beyond, a base station for 6G).

FIG. 9 is a block diagram illustrating the main components of an exemplary CU, for example a CU part of base station (‘eNB’ in LTE, ‘gNB’ in 5G, a base station for 5G beyond, a base station for 6G).

FIG. 10 is a block diagram illustrating the main components of the AMF.

FIG. 11 is a block diagram illustrating the main components of the SMF.

FIG. 12 is a block diagram illustrating the main components of the UPF.

FIG. 13 is a block diagram illustrating the main components of the PCF.

FIG. 14 is a block diagram illustrating the main components of the NEF.

FIG. 15 is a block diagram illustrating the main components of the UDM.

FIG. 16 is a block diagram illustrating the main components of the NWDAF.

### DESCRIPTION OF EMBODIMENTS

### Abbreviations

For the purposes of the present document, the abbreviations given in NPL 4 and the following apply. An abbreviation defined in the present document takes precedence over the definition of the same abbreviation, if any, in NPL 4.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
ABBA Anti-Bidding-down Between Architectures
AF Application Function
AMF Access and Mobility Management Function
API Application Programming Interface
AS Access Stratum
ATSSS Access Traffic Steering, Switching, Splitting
ATSSS-LL ATSSS Low-Layer
AUSF Authentication Server Function
AUTN Authentication token
BBF Broadband Forum
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
CU Centralized Unit
DAPS Dual Active Protocol Stacks
DL Downlink
DN Data Network
DNAI DN Access Identifier
DNN Data Network Name
DRX Discontinuous Reception
DS-TT Device-side TSN translator
DU Distributed Unit
ePDG evolved Packet Data Gateway
EAP Extensible Authentication Protocol
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI International Mobile Equipment Identity
IMEI/TAC IMEI Type Allocation Code
IMS IP Multimedia Subsystem
IOWN Innovative Optical and Wireless Network
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
LTE Long Term Evolution
MAC Medium Access Control
MCC Mobile country code
MCX Mission Critical Service
MDBV Maximum Data Burst Volume
MFBR Maximum Flow Bit Rate
MICO Mobile Initiated Connection Only
MNC Mobile Network Code
MO Mobile Originated
MPS Multimedia Priority Service
MPTCP Multi-Path TCP Protocol
MT Mobile Terminated
MT Mobile Termination
N3IWF Non-3GPP InterWorking Function
N5CW Non-5G-Capable over WLAN
NAI Network Access Identifier
NAS Non-Access Stratum
NEF Network Exposure Function
NF Network Function
NGAP Next Generation Application Protocol
ngKSI Next Generation Key Set Identifier
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NW-TT Network-side TSN translator
NWDAF Network Data Analytics Function
O-RAN Open RAN Alliance
O-DU O-RAN Distributed Unit
O-CU O-RAN Centralized Unit
O-RU O-RAN Radio Unit
PCF Policy Control Function
PDB Packet Delay Budget
PDCP Packet Data Convergence Protocol
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
QoS Quality of Service
RACS Radio Capabilities Signalling optimization
(R)AN (Radio) Access Network
RG Residential Gateway
RU Radio Unit
RIM Remote Interference Management
RLC Radio Link Control
RQA Reflective QoS Attribute
RQI Reflective QoS Indication
RRC Radio Resource Control
RSN Redundancy Sequence Number
SA NR Standalone New Radio
SBA Service Based Architecture
SBI Service Based Interface
SCP Service Communication Proxy
SD Slice Differentiator
SDAP Service Data Adaptation Protocol
SEAF Security Anchor Functionality
SEPP Security Edge Protection Proxy
SMF Session Management Function
SMS Short Message Service
SMSF Short Message Service Function
SN Sequence Number
SN name Serving Network Name.
SNPN Stand-alone Non-Public Network
S-NSSAI Single Network Slice Selection Assistance Information
SOR Steering Of Roaming
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAI Tracking Area Identity
TCP Transmission Control Protocol
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UP User Plane
UPF User Plane Function
URLLC Ultra Reliable Low Latency Communication
URRP-AMF UE Reachability Request Parameter for AMF
URSP UE Route Selection Policy
UU Interface between User Equipment and Radio Access Network
VID VLAN Identifier
VLAN Virtual Local Area Network
W-5GAN Wireline 5G Access Network
W-5GBAN Wireline BBF Access Network
W-5GCAN Wireline 5G Cable Access Network
W-AGF Wireline Access Gateway Function
WLAN Wireless Local Area Network
WUS Wake Up Signal

### Definitions

For the purposes of the present document, the terms and definitions given in NPL 4 and the following apply. A term defined in the present document takes precedence over the definition of the same term, if any, in NPL 4.

Home network: A network owning the current in use subscription/credential of the UE. Home network can be either PLMN or NPN.

Home network service: Service, which is offered to UE based on subscription agreed with home network operator.

Hosting network: A network providing access to Local/Localized services.

Local service, Localized service: Service offered by hosting network operator, which is localized (i.e., provided at specific/limited area) and/or can be bounded in time. The service can be realized via applications (e.g., live or on-demand audio/video stream, electric game, IMS, etc), or connectivity (e.g., UE to UE, UE to Data Network, etc.).

Non-Public Network (NPN): A network that is intended for non-public use. NPN can be used as the home network or a temporary hosting network to provide localized services.

Public network integrated NPN: A non-public network deployed with the support of a PLMN.

Return to home network: UE leaves the hosting network (e.g., when the Local/Localized service is terminated), and resumes to use subscription/credential of home network. It can involve a network selection (e.g., select HPLMN or VPLMN) and can involve deactivation/activation of SNPN access mode.

Stand-alone Non-Public Network (SNPN): A non-public network not relying on network functions provided by a PLMN.

### First Aspect (Solution 1)

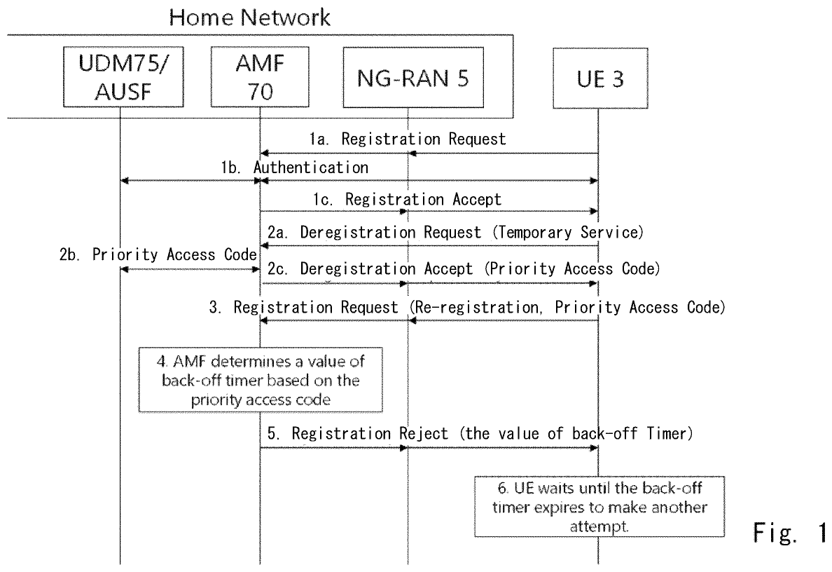

Referring to FIG. 1, this aspect comprises a method for minimizing the service impact of UEs when returning to their home network by assigning a priority access code to UEs while leaving the home network. The service impact is caused by a huge number of UEs return to the home network within a short period of time.

The home network in this aspect can be a PLMN or a Stand-alone NPN (SNPN).

A PLMN is a typical mobile network managed by a telecommunication operator.

An NPN may be categorized into an SNPN or a Public Network Integrated NPN (PNI-NPN).

As indicated in NPL 3, an SNPN is operated by an NPN operator and does not rely on network functions provided by a PLMN.

A PNI-NPN, is a non-public network deployed with the support of a PLMN.

A priority access code is a kind of data element for prioritizing which UEs should be registered as early as possible.

The priority access code can be based on allowed service and subscriber category information. The subscriber category information may, for example, be as defined in NPL 5.
The value of the priority access code may be represented by text such as “high” “medium”, and “low”.
The value may also be represented by numbers like 1 denotes high priority, 2 denotes medium priority, and 3 denotes low priority.
The Allowed service is a piece of information which may comprise any number of service identifiers allowed for the subscriber in the PDU Session.
Based on the allowed service, for example, a high priority may be given to services that the operator specifies.
The subscriber category is another piece of information which may comprise any number of identifiers associated with the subscriber (e.g. gold, silver, etc.).
Based on the subscribe service information, for example, a high priority may be given to subscribers whose subscribe category is gold.

A priority access code can be unique to an individual subscriber within the same subscriber category for prioritizing that individual subscriber within that subscriber category.
For example, the value of the priority access code may be a unique sequence of characters.
Different priority access codes are, in this example, not overlapped with each other. A sequence of characters, like an SSH key or a Universally Unique Identifier, is a possible example.

A priority access code can also be represented by a structured data element. All, one, or a combination of the following attributes can be used to structure such a priority access code:
A priority class attribute, as described above, representing “high”, “medium”, and “low”, or a unique sequence of characters.
A generated time attribute representing when the priority access code is generated.
An owner identifier representing who generated the priority access code.
An expiration time that indicates a valid period of the priority access code value.

In this example, the priority access code is used to generate a random back-off timer value in the home network. The UDM and/or AUSF may generate/provide/send the priority access code. Or the AMF may generate the priority access code.

A random back-off timer is a kind of random data value based on the priority access code. The value of the random back-off timer is, for example, small (short time) if a priority access code used is “high”. And the value of the random back-off timer is high (long time) if a priority access code used is “low”. The value of the random back-off timer is determined so that the value is fully distributed if overlapping of the value is not allowed.

In another case, the overlapping of the value of the random back-off timer may be allowed if there is an upperlimit of the overlappings. In this case, multiple UEs who has the same value of the random back-off timer can retry registrations at the same time within the upperlimit.

The value of the random back-off timer is determined by the home network based on the priority access code. For example, for a higher priority access code, the home network can determine a value of the random back-off timer from a range of possible values that are shorter than (or more likely to be shorter than) for a lower priority access code. Instead of using the same pre-defined range (e.g., 1-1024 seconds) to assign random back-off timer value to all UEs irrespective of their service schedule or priority, a new range (e.g., 1-128 seconds) is assigned for random back-off timer based on the priority access code of UEs.

The value of the random back-off timer is provided to the UE and used to compute when the UE triggers a registration to the home network when the UE returns to the home network.

Accordingly, a UE with a higher priority access code will be able to get a shorter random back-off timer value and execute the registration process earlier than for other UEs with a lower priority access code.

This reduces the overall waiting time for UEs with a high priority to re-register to their home network.

FIG. 1 will now be described in more detail by way of example only. FIG. 1 shows priority based re-registration procedure.

1a. A UE3 initiates registration with the home network for accessing the available services. The UE3 sends a registration request message to the AMF70.

1b. The authentication procedure is performed and the UE3 is authorized to access the services from the home network.

1c. The AMF70 in the home network accepts the registration request of UE3. The AMF70 sends the registration accept message to the UE3.

2a. After accessing a service from the home network, the UE3 decides to leave temporarily and plan to return back after some time. The UE3 sends a deregistration request message to the AMF70 in the home network. In the deregistration request, “Temporary Service” indicates a status that the UE3 is going to deregister from the homenetwork temporarily. If “Temporary Service” is, for example, typed as a Boolean data, the status shows that the UE3 would come back to the home network in a certain time. If “Temporary Service” is, for example, typed as a structured data, then “Temporary Service” could be composed by multiple attributes. An attribute indicates a status that the UE3 is going to deregister from the home?network temporarily. Another attribute indicates an expired time for the status. If the expired time is expired, then the UE3 is handled as deregistered. In the AMF70, other attributes such as a time stamp to record when the registration is processed, a transaction id so that the deregistration request is uniquely identified may be added.

2b. The home network provides a priority access code value if “Temporary Service” is indicated in the deregistration request. As described, the priority access code value is used to prioritize the re-registration process of the UE3 when the UE3 returns back to the home network. The priority access code value may be based on subscriber information for the UE3.

Based on the indication of temporary service in the deregistration request message of the UE3, the AMF70 in the home network gets the priority access code value of the UE3 from the UDM75.

2c. The AMF70 sends the deregistration accept message to the UE3. The AMF70 includes the priority access code in the deregistration accept message. If an expiration time may be included with the priority access code in the deregistration accept message, the expiration time may be counted/timed after the UE3 receives the deregistration accept message.

3. As specified in clause 4.2.2 in TS 23.502, there are different registration types such as initial registration, mobility registration update, periodic registration update, emergency registration, disaster roaming initial registration, disaster roaming mobility registration update, and SNPN onboarding registration. In this aspect, a new registration type Re-registration to indicate to the home network that the UE3 is returning from a hosting network to the home network after accessing a temporary localized service.

The UE3 may select the home network. The UE3 initiates the registration procedure. The UE3 sends the registration request message to the AMF70. The UE3 may include “Re-registration” in the registration request message. “Re-registration” is a new registration type used to differentiate from other registration types. “Re-registration” is used by the UE3 which indicated a status “Temporary Service” while deregistering from the home network temporarily (step 2a), which has a priority access code from the home network (step 2c). The UE3 does not use the priority access code value in a case where the expiration time has expired.

4. Depending on congestion, the home network may accept or reject the registration request of the UE3. The decision, accept or reject, in the AMF70 is made based on the priority access code when deciding whether to accept or reject the registration requests of UEs. The AMF70 may determine to accept the registration request message based on the registration request message including the priority access code, and/or based on the priority access code indicating high priority. If the priority access code indicates “low”, then the registration is rejected. If registration of the UE3 is rejected due to congestion, the AMF70 in the home network determines the back-off timer value based on the “priority access code value”. The back-off timer value will be i) a relatively short time if the “priority access code value” indicates a high priority and ii) a relatively long time if the “priority access code value” indicates a low priority. The back-off time values are also distributed so that they are not overlapped relative to one another.

5. The home network rejects the registration request message of the UE3 and provides a “Back-off Timer Value” to the UE3 as determined in step 4. The AMF70 sends the registration reject message including the Back-off Timer value to the UE3.

6. The UE3 waits until the back-off timer expires to make another attempt for the registration procedure. The UE3 then sends the registration request message after the back off timer value has expired from the receipt the registration reject message in the step 5.

### Variant 1 of Solution 1

In a variant of solution1, if the home network initiates the deregistration procedure to allow the UE3 to leave the home network temporarily, then the priority access code value may be indicated in the deregistration request message sent to the UE3 by the home network. The AMF70 sends the deregistration request message including the priority access code value to the UE3.

### Variant 2 of Solution 1

In another variant of solution1, in step 2a the UE3 may send a NAS message indicating the temporary deregistration of the UE3 from the home network. Alternatively or additionally, in the step 2c the AMF70 may send a NAS message indicating a priority access code value. The NAS message may be, for example, a UE configuration update command message.

### Second Aspect (Solution 2)

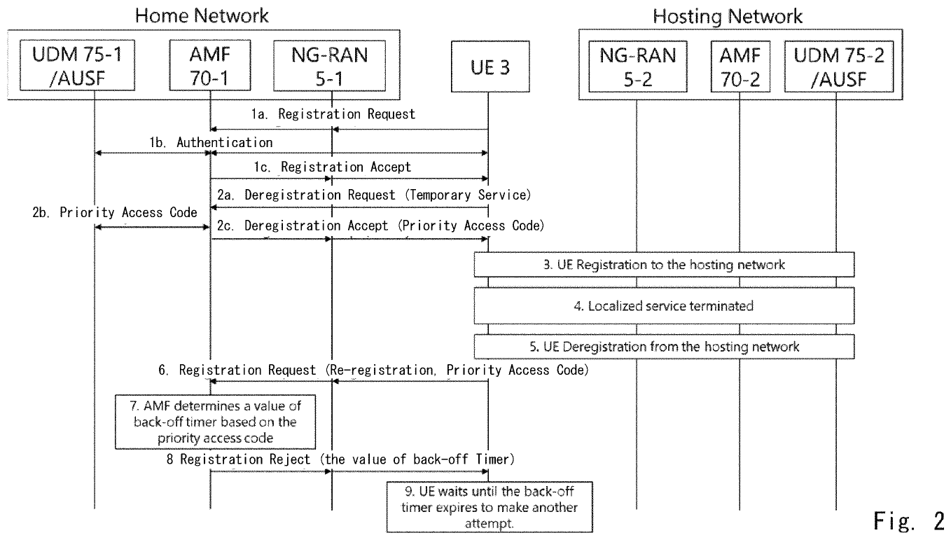

Referring to FIG. 2, this aspect comprises a method for minimizing the service impact of UEs when returning to their home network from a localized hosting network by assigning a priority access code to UEs, while leaving the home network, before registering to a hosting network for accessing localized services. When a UE returns to the UE's home network from a localized hosting network after accessing a localized service, the home network assigned priority access code to that UE is used to assign a random back-off timer to mitigate overload while not affecting the quality of service and experience of users.

A Non-Public Network (NPN) based hosting network is considered here. There are two types of NPNs: Stand-alone NPN (SNPN) and Public Network Integrated NPN (PNI-NPN). Both types of NPNs can be used as hosting networks to access the localized services. The home network can be a PLMN or an SNPN. The home network assigns a priority access code to a UE when the UE is about to leave the home network as part of the deregistration procedure. The priority access code can be based on the UE's subscriber information and allowed services (NPL 5).

Then, the UE registers to one of the available hosting networks in a local environment, based on their choice, to access a localized service. In most cases, UEs return to their home network immediately if the localized service is terminated. Therefore, there is a possibility that a high number of UEs will return to their home network from a localized hosting network in a short period of time. This could lead to overload. A random back-off timer can be assigned to each UE to mitigate overload at the home network. Here, the random back-off timer is assigned to a UE by the home network based on the UE's priority access code that was previously assigned by the same home network. Accordingly, the assigned priority access code to a UE is used by the home network to decide (a suitable back-off timer value based on the priority access code assigned to the UE) when to admit UEs to re-register to their home network such that overload conditions can be mitigated while not affecting the quality of service and experience of users by considering a UE's service schedule and access pattern. This also reduces the overall waiting time for UEs to re-register to their home network after leaving from the localized hosting network.

FIG. 2 will now be described in more detail by way of example only. FIG. 2 shows priority based re-registration procedure between home and hosting network.

1a. A UE3 initiates registration with the home network for accessing the available services. The UE3 sends a registration request message to the AMF70-1 in the home network.

1b. The authentication procedure is performed and the UE3 is authorized to access the services from the home network.

1c. The AMF70-1 in the home network accepts the registration request of UE3. The AMF70-1 sends the registration accept message to the UE3.

2a. The UE3 sends a deregistration request message to the AMF70-1 in the home network. In the deregistration request, “Temporary Service” indicates a status that the UE3 is going to deregister from the home network temporarily. This means that the UE3 will come back to the home network in a certain time. The information “Temporary Service” can be structured as a Boolean data type. The “Temporary Service” may be an indication of temporary deregistration of the UE3 from the home network and/or that the UE3 is going to perform Re-Registration procedure to the AMF70-1.

The UE3 may include identifier of the hosting network in the deregistration request message. The identifier of the hosting network indicates that the UE3 will temporarily register to the hosting network after the temporary deregistration from the home network. The identifier of the hosting network may be a PLMN ID.

2b. The home network provides a priority access code value if “Temporary Service” is indicated in the deregistration request. The priority access code value is used to prioritize the re-registration process of the UE3 when the UE3 returns from a hosting network. The priority access code value may be based on subscriber information for the UE3. For example, a value of the priority access code, 1 may denote a high priority, 2 may denote a medium priority, and 3 may denote a low priority (or vice versa).

Based on the indication of temporary service in the deregistration request message of the UE3, the AMF70-1 in the home network gets the priority access code value of the UE3 from the UDM75 in the home network.

The priority access code value may be generated based on the identifier of the hosting network.

2c. The AMF70-1 sends the deregistration accept message to the UE3. The AMF includes the priority access code value in the deregistration accept message. The expiration time may be included with the priority access code value in the deregistration accept message. The expiration time may be counted/timed after the UE receives the deregistration accept message.

3. The UE3 registers to the hosting network to access the localized service. The UE3 sends the registration request message to the AMF70-2 in the hosting network. The UE3 receives the registration accept message from the AMF70-2. Then the localized service is provided to the UE3.

4. The localized service is terminated in the hosting network.

5. The UE3 deregisters from the hosting network. The UE3 sends a deregistration request message to the AMF70-2. The AMF70-2 sends a deregistration accept message with its network identifier (e.g. NPN or PLMN id) to the UE2. Alternatively, the AMF70-2 sends a deregistration request message to the UE3 and the UE3 sends a deregistration accept message to the AMF70-2.

6. The UE3 may select the home network. The UE3 initiates the registration procedure. The UE3 sends the registration request message to the AMF70-1. The UE3 may include “Re-registration” in the registration request message. “Re-registration” is a new registration type used to differentiate from other registration types. “Re-registration” is used by the UE3 which indicated a status “Temporary Service” while deregistering from the home network temporarily (step 2a), which has a priority access code from the home network (step 2c). The UE3 does not use the priority access code value in a case where the expiration time has expired. The UE3 may include the identifier of the hosting network in the registration request message.

A new attribute, network id, is introduced if the priority access code is typed as a structured data. The network id is given by the hosting network in the step5. With this attribute, the AMF70-1 identifies which hosting network the UE3 attached before.

7. Depending on congestion, the home network may accept or reject the registration request of the UE3. The home network may consider the priority access code value when deciding whether to accept or reject the registration requests of UEs. The AMF70-1 may determine to accept the registration request message based on the registration request message including the priority access code value, and/or based on the priority access code value indicating high priority.

The AMF70-1 may consider the network identifier of the hosting network if UEs are returning from multiple hosting networks in a short period of time. If the identifier of the hosting network included in the registration request message does not match the identifier of network associated with the priority access code value, the AMF70-1 may determine to ignore the priority access code value.

If re-registration of the UE3 is rejected due to congestion, the AMF70-1 in the home network determines the back-off timer value based on the “priority access code value”. The back-off timer value will be i) a relatively short time if the “priority access code value” indicates a high priority and ii) a relatively long time if the “priority access code value” indicates a low priority. The back-off time values are also distributed so that they are not overlapped relative to one another.

8. The home network rejects the registration request message of the UE3 and provides a “Back-off Timer Value” to the UE3 as determined in step 7. The AMF70-1 sends the registration reject message including the Back-off Timer value to the UE3.

In general, if the registration request message is rejected due to congestion, then a random back-off timer value is assigned to the UE to indicate that the UE should wait for a random time before making an attempt to re-register, such that all UEs will not make attempt to register at the same time, and hence reduce congestion. However, if the same pre-defined range is used to assign a random back-off timer value to all UEs irrespective of their service schedule or priority, then it would increase the waiting time of UEs and affect their service.

In this aspect, a pre-defined range to generate the random value is set depending on the priority level. Hence, if the registration request message is rejected due to congestion, then the back-off timer value is assigned to the UE based on the priority access code value (i.e., different pre-defined ranges are used to assign random back-off timer value to UEs based on their priority level). A relatively low back-off timer value is assigned to high priority UE(s) and a relatively high back-off timer value is assigned to low priority UE(s). This helps to minimize UEs' service impact when re-registering back to their home network after accessing a temporary localized service from a hosting network.

9. The UE3 waits until the back-off timer value expires to make another attempt for the registration procedure. The UE3 sends the registration request message to the AMF70-1 after the back off timer value has expired from the receipt the registration reject message in the step 8.

### Variant 1 of Solution 2

In a variant of solution 2, if the home network initiates the deregistration procedure to allow the UE3 to access a temporary localized service, then the priority access code value may be indicated in the deregistration request message sent to the UE3. The AMF70-1 sends the deregistration request message including the priority access code value to the UE3.

### Variant 2 of Solution 2

In another variant of solution 2, in step 2a the UE3 may send a NAS message indicating the temporary deregistration of the UE3 from the home network. Alternatively or additionally, in step 2c the AMF70-1 may send a NAS message indicating a priority access code value. The NAS message may be, for example, a UE configuration update command message.

### System Overview

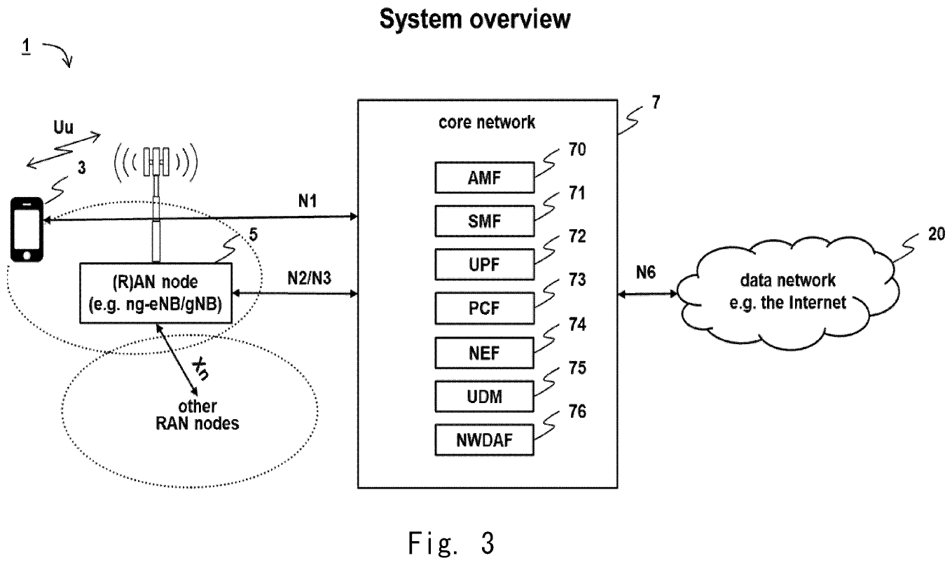

FIG. 3 schematically illustrates a telecommunication system 1 for a mobile (cellular or wireless) device (known as a user equipment (UE)) to which the above aspects are applicable.

The telecommunication system 1 represents a system overview in which an end-to-end communication is possible. For example, the UE 3 (or user equipment, ‘mobile device’ 3) communicates with other UEs 3 or service servers in the data network 20 via respective (R)AN nodes 5 and a core network 7.

The (R)AN node 5 supports any suitable radio access technology including, for example, a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may be split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, 0-DU and O-CU respectively.

The (R)AN node 5 may be split into one or more control plane functions and one or more user plane functions. Further, multiple user plane functions can be allocated to support a communication. In some aspects, user traffic may be distributed to multiple user plane functions and user traffic over each user plane function is aggregated in both the UE 3 and the (R)AN node 5. This split architecture may be called ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN nodes 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane and User plane.

The User plane of the Uu interface is responsible for conveying user traffic between the UE 3 and a serving (R)AN node 5. The User plane of the Uu interface may have a layered structure with SDAP, PDCP, RLC and MAC sublayer over the physical connection.

The Control plane of the Uu interface is responsible for establishing, modifying and releasing a connection between the UE 3 and a serving (R)AN node 5. The Control plane of the Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by embodiments in this disclosure, any of the following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by embodiments in this disclosure, any of the following parameters may be included together in the RRC Setup message.
   masterCellGroup and radioBearerConfig
RRC Setup Complete message: This message is sent from the UE 3 to the (R)AN node 5. In addition to the parameters that are disclosed by embodiments in this disclosure, any of the following parameters may be included together in the RRC Setup Complete message.
   guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible for providing a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by embodiments in this disclosure, any of the following parameters may be included together in the Registration Request message.
   5GS registration type, ngKSI, 5GS mobile identity, Non-current native NAS key set identifier, 5GMM capability, UE security capability, Requested NSSAI, Last visited registered TAI, Si UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by embodiments in this disclosure, any of the following parameters may be included together in the Registration Accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by embodiments in this disclosure, the following parameter may be included together in the Registration Complete message.
   SOR transparent container.
Authentication Request message: This message is sent from the AMF 70 to the UE 3. In addition to the parameters that are disclosed by embodiments in this disclosure, any of the following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by embodiments in this disclosure, any of the following parameters may be populated together in the Authentication Response message.
   Authentication response message identity, Authentication response parameter and EAP message.
Authentication Result message: This message is sent from the AMF 70 to the UE 3. In addition to the parameters that are disclosed by embodiments in this disclosure, any of the following parameters may be populated together in the Authentication Result message.
   ngKSI, EAP message and ABBA.
Authentication Failure message: This message is sent from the UE 3 to the AMF 70. In addition to the parameters that are disclosed by embodiments in this disclosure, any of the following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by embodiments in this disclosure, the following parameter may be populated together in the Authentication Reject message.
   EAP message.
Service Request message: This message is sent from the UE 3 to the AMF 70. In addition to the parameters that are disclosed by embodiments in this disclosure, any of the following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by embodiments in this disclosure, any of the following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by embodiments in this disclosure, any of the following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by embodiments in this disclosure, any of the following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by embodiments in this disclosure, the following parameter may be populated together in the Configuration Update Complete message.
   Configuration update complete message identity.

### User Equipment (UE)

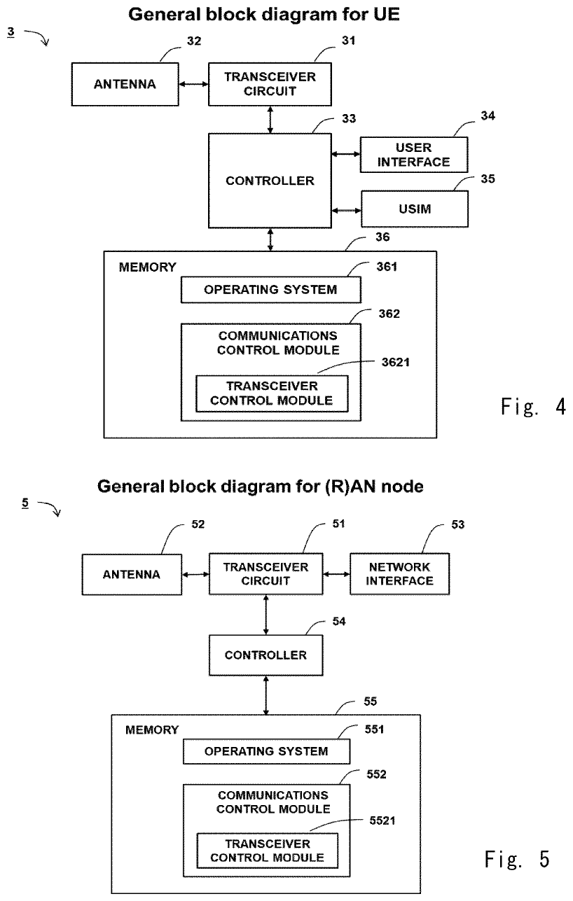

FIG. 4 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (e.g. a removable memory device (RMD)), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### (R)AN Node

FIG. 5 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (e.g. an RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

### System Overview of (R)AN Node 5 Based on O-RAN Architecture

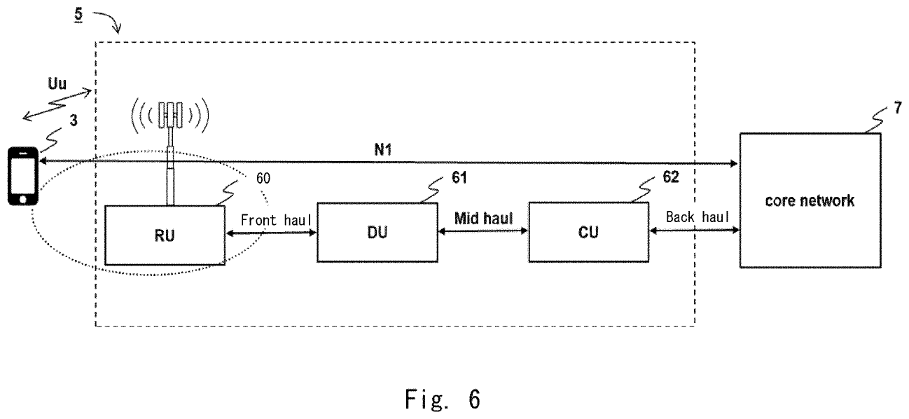

FIG. 6 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionality to communicate with a UE 3 over air interface, the DU 61 may provide functionalities to support MAC layer and RLC layer, the CU 62 may provide functionalities to support PDCP layer, SDAP layer and RRC layer.

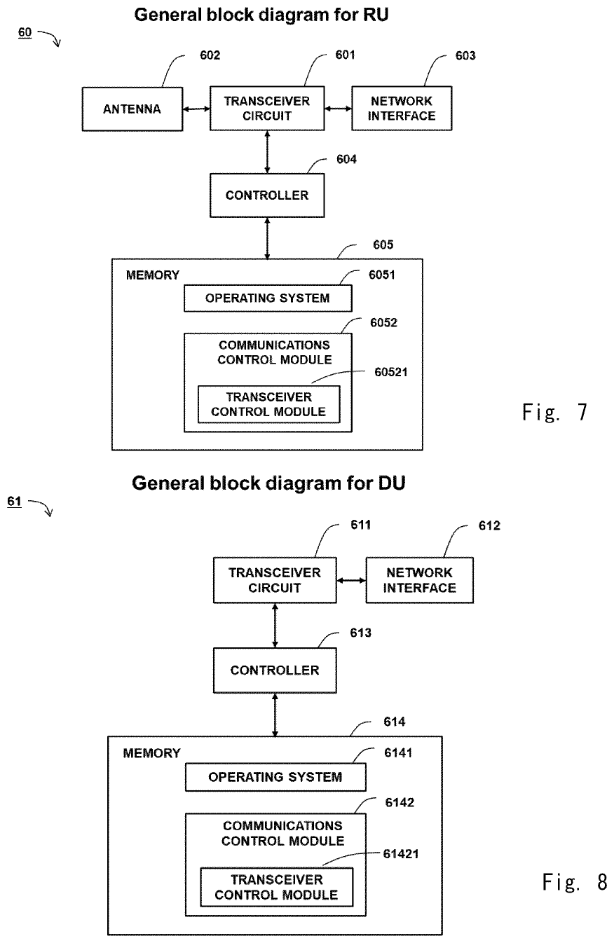

FIG. 7 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (e.g. a removable memory device (RMD)), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

FIG. 8 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (e.g. a removable memory device (RMD)), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the DU 61 can be integrated/combined with the RU 60 or CU 62 as an integrated/combined unit. Any functionality in the description for DU 61 can be implemented in one of the integrated/combined unit above.

### Centralized Unit (CU)

FIG. 9 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (e.g. a removable memory device (RMD)), for example. The software includes, among other things, an operating system 6241 and a communications control module 6242 having at least a transceiver control module 62421. The communications control module 6242 (using its transceiver control module 62421) is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### AMF

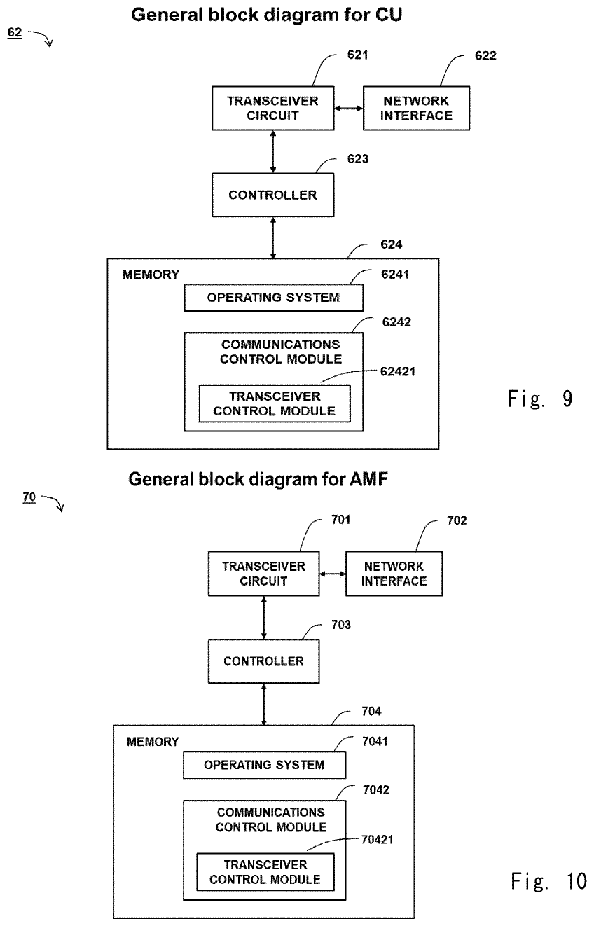

FIG. 10 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (e.g. a removable memory device (RMD)), for example. The software includes, among other things, an operating system 7041 and a communications control module 7042 having at least a transceiver control module 70421. The communications control module 7042 (using its transceiver control module 70421) is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in). Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### SMF

FIG. 11 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control module 71421) is responsible for handling (generating/sending/receiving) signalling between the SMF 71 and other nodes, such as the UPF 72 and other core network nodes (including core network nodes in the HPLMN of the UE 3 when the UE 3 is roaming-in). Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### UPF

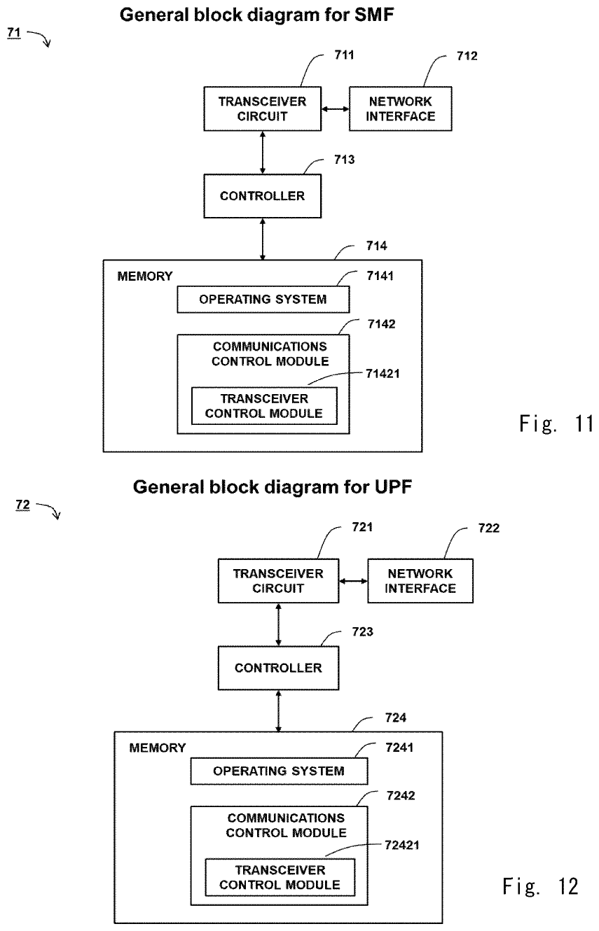

FIG. 12 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421) is responsible for handling (generating/sending/receiving) signalling between the UPF 72 and other nodes, such as the SMF 71 and other core network nodes (including core network nodes in the HPLMN of the UE 3 when the UE 3 is roaming-in). Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### PCF

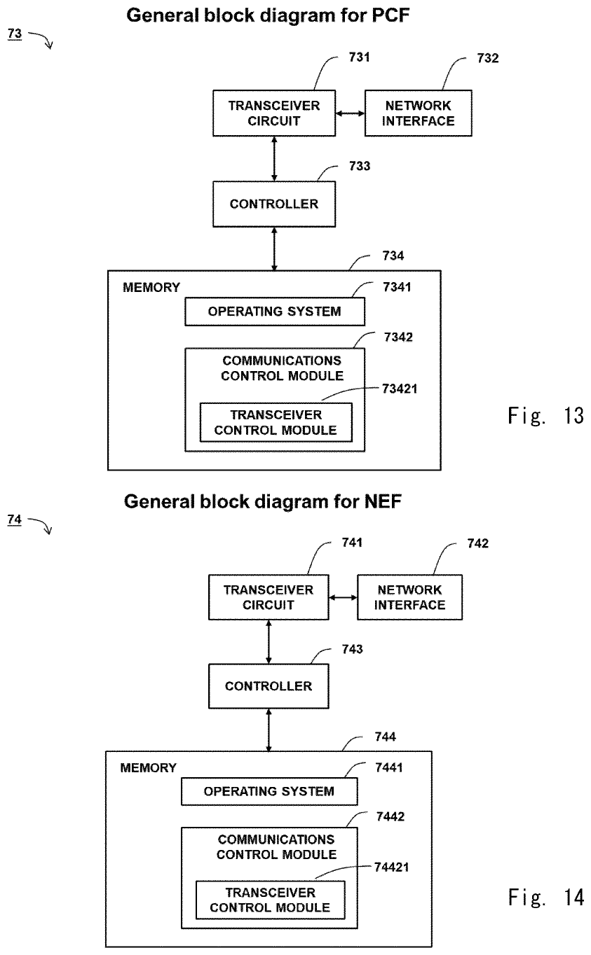

FIG. 13 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421) is responsible for handling (generating/sending/receiving) signalling between the PCF 73 and other nodes, such as the AMF 70 and other core network nodes (including core network nodes in the HPLMN of the UE 3 when the UE 3 is roaming-in). Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### NEF

FIG. 14 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421) is responsible for handling (generating/sending/receiving) signalling between the NEF 74 and other nodes, such as the UDM 75 and other core network nodes (including core network nodes in the HPLMN of the UE 3 when the UE 3 is roaming-in). Such signalling may include, for example, appropriately formatted signalling messages (e.g. a HTTP restful methods based on the service based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### UDM

FIG. 15 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (e.g. a removable memory device (RMD)), for example. The software includes, among other things, an operating system 7541 and a communications control module 7542 having at least a transceiver control module 75421. The communications control module 7542 (using its transceiver control module 75421) is responsible for handling (generating/sending/receiving) signalling between the UDM 75 and other nodes, such as the AMF 70 and other core network nodes (including core network nodes in the VPLMN of the UE 3 when the UE 3 is roaming-out). Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### NWDAF

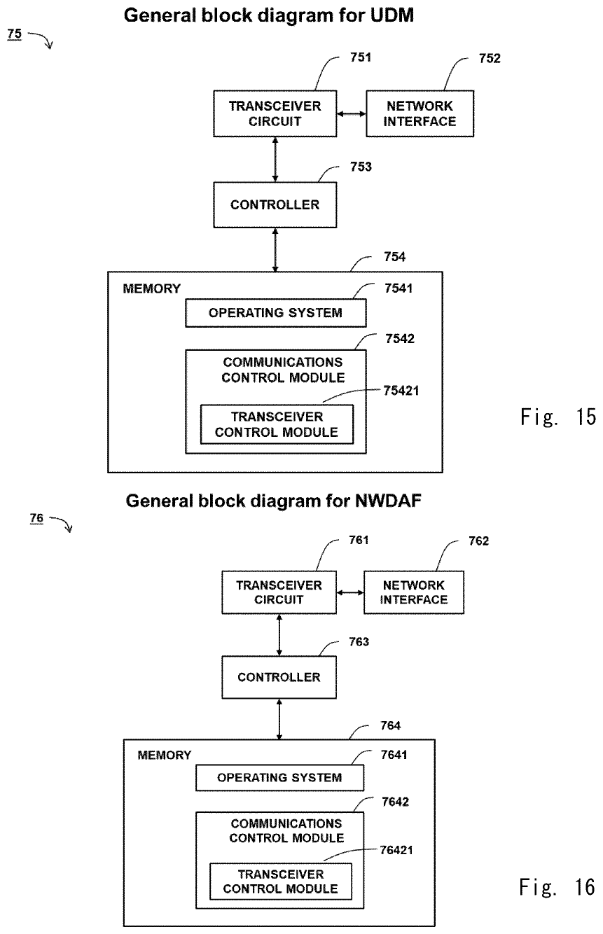

FIG. 16 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421) is responsible for handling (generating/sending/receiving) signalling between the NWDAF 76 and other nodes, such as the AMF 70 and other core network nodes (including core network nodes in the HPLMN of the UE 3 when the UE 3 is roaming-in). Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

This application is based upon and claims the benefit of priority from Indian provisional patent application No. 202211069643, filed on Dec. 2, 2022, the disclosure of which is incorporated herein in its entirety by reference.

Various other modifications will be apparent to those skilled in the art and will not be described in further detail here.

### Supplementary Note 1

A method performed by a first core network node in a first core network, the method comprising:
receiving, from a user equipment (UE), a first message including first information indicating temporary deregistration of the UE from the first core network;
transmitting, to the UE, a second message including second information indicating a priority code for registration of the UE to the first core network, wherein the priority code is based on the first information; and
receiving, from the UE, a third message for registration, the third message indicating the priority code.

### Supplementary Note 2

The method according to Supplementary note 1, wherein
the third message indicates re-registration of the UE to the first core network.

### Supplementary Note 3

The method according to Supplementary note 1, further comprising:
generating the priority code based on subscription information for the UE with a second core network node in the first core network.

### Supplementary Note 4

The method according to Supplementary note 1, further comprising:
transmitting, to the UE, a fourth message in response to the third message, the fourth message indicating a rejection for the third message and a backoff time, wherein the backoff time is based on the priority code.

### Supplementary Note 5

The method according to Supplementary note 1, wherein
the first message includes an identifier of a second core network to which the UE temporarily registered after the temporary deregistration of the UE from the first core network, and
the priority code is based on the identifier of the second core network.

### Supplementary Note 6

The method according to Supplementary note 5, wherein
the third message includes third information indicating that the UE has returned from the second core network, and
the method further comprises
determining whether the priority code is valid based on the third information.

### Supplementary Note 7

The method according to Supplementary note 1, wherein
the priority code is indicated with an expiration time of the priority code, and
the method further comprises
receiving, from the UE, a fifth message for registration, the fifth message not including the priority code in a case where the expiration time is expired.

### Supplementary Note 8

The method according to Supplementary note 1, wherein
the first message is a deregistration request message,
the second message is deregistration accept message, and
the third message is registration request message.

### Supplementary Note 9

The method according to Supplementary note 3, wherein
the first core network node in the first core network is an Access and Mobility Management Function (AMF) in a home network, and
the second core network node is a Unified Data Management (UDM).

### Supplementary Note 10

A method of a user equipment (UE), the method comprising:
transmitting, to a first core network node in a first core network, a first message including first information indicating temporary deregistration of the UE from the first core network; and
receiving, from the first core network node, a second message including second information indicating a priority code for registration of the UE to the first core network, wherein the priority code is based on the first information.

### Supplementary Note 11

The method according to Supplementary note 10, further comprising
transmitting, to the first core network node, a third message for registration, the third message indicating the priority code.

### Supplementary Note 12

The method according to Supplementary note 11, wherein
the third message indicates re-registration of the UE to the first core network.

### Supplementary Note 13

The method according to Supplementary note 10, wherein
the priority code is generated based on subscription information for the UE with a second core network node in the first core network.

### Supplementary Note 14

The method according to Supplementary note 11, further comprising:
receiving, from the first core network, a fourth message in response to the third message, the fourth message indicating a rejection for the third message and a backoff time, wherein the backoff time is generated based on the priority code; and
transmitting, to the first core network node, a fifth message for registration after the backoff time has expired from the receipt of the fourth message.

### Supplementary Note 15

The method according to Supplementary note 11, wherein
the first message includes an identifier of a second core network to which the UE temporarily registered after the temporary deregistration of the UE from the first core network, and
the priority code is based on the identifier of the second core network.

### Supplementary Note 16

The method according to Supplementary note 15, wherein
the third message includes third information indicating that the UE has returned from the second core network, and
the priority code is checked based on the third information.

### Supplementary Note 17

The method according to Supplementary note 10, wherein
the priority code is indicated with an expiration time of the priority code, and
the method further comprises
transmitting, to the first core network node, a fifth message for registration, the fifth message not including the priority code in a case where the expiration time is expired.

### Supplementary Note 18

The method according to Supplementary note 11, wherein
the first message is a deregistration request message,
the second message is deregistration accept message, and
the third message is registration request message.

### Supplementary Note 19

The method according to Supplementary note 13, wherein
the first core network node in the first core network is an Access and Mobility Management Function (AMF) in a home network, and
the second core network node is a Unified Data Management (UDM).

### Supplementary note 20

A first core network node in a first core network, the first core network node comprising:
a memory storing instructions; and
at least one hardware processor configured to process the instructions to:
   receive, from a user equipment (UE), a first message including first information indicating temporary deregistration of the UE from the first core network;
   transmit, to the UE, a second message including second information indicating a priority code for registration of the UE to the first core network, wherein the priority code is based on the first information; and
   receive, from the UE, a third message for registration, the third message indicating the priority code.

### Supplementary Note 21

A user equipment (UE) comprising:
a memory storing instructions; and
at least one hardware processor configured to process the instructions to:
   transmit, to a first core network node in a first core network, a first message including first information indicating temporary deregistration of the UE from the first core network; and
   receive, from the first core network node, a second message including second information indicating a priority code for registration of the UE to the first core network, wherein the priority code is based on the first information.

### REFERENCE SIGNS LIST

1 telecommunication system
3 user equipment (UE)
31 transceiver circuit
32 antenna
33 controller
34 user interface
35 Universal Subscriber Identity Module (USIM)
36 memory
361 operating system
362 communications control module
3621 transceiver control module
5 (R)AN node
51 transceiver circuit
52 antenna
53 network interface
54 controller
55 memory
551 operating system
552 communications control module
5521 transceiver control module
20 data network
60 Radio Unit (RU)
601 transceiver circuit
602 antenna
603 network interface
604 controller
605 memory
6051 operating system
6052 communications control module
60521 transceiver control module
61 Distributed Unit (DU)
611 transceiver circuit
612 network interface
613 controller
614 memory
6141 operating system
6142 communications control module
61421 transceiver control module
62 Centralized Unit (CU)
621 transceiver circuit
622 network interface
623 controller
624 memory
6241 operating system
6242 communications control module
62421 transceiver control module
7 core network node
70 Access and Mobility Management Function (AMF)
701 transceiver circuit
702 network interface
703 controller
704 memory
7041 operating system
7042 communications control module
70421 transceiver control module
71 Session Management Function (SMF)
711 transceiver circuit
712 network interface
713 controller
714 memory
7141 operating system
7142 communications control module
71421 transceiver control module
72 User Plane Function (UPF)
721 transceiver circuit
722 network interface
723 controller
724 memory
7241 operating system
7242 communications control module
72421 transceiver control module
73 Policy Control Function (PCF)
731 transceiver circuit
732 network interface
733 controller
734 memory
7341 operating system
7342 communications control module
73421 transceiver control module
74 Network Exposure Function (NEF)
741 transceiver circuit
742 network interface
743 controller
744 memory
7441 operating system
7442 communications control module
74421 transceiver control module
75 Unified Data Management (UDM)
751 transceiver circuit
752 network interface
753 controller
754 memory
7541 operating system
7542 communications control module
75421 transceiver control module
76 Network Data Analytics Function (NWDAF)
761 transceiver circuit
762 network interface
763 controller
764 memory
7641 operating system
7642 communications control module
76421 transceiver control module

What is claimed is:

1. A method performed by a first core network node in a first core network, the method comprising:
receiving, from a user equipment (UE), a first message including first information indicating temporary deregistration of the UE from the first core network;
transmitting, to the UE, a second message including second information indicating a priority code for registration of the UE to the first core network, wherein the priority code is based on the first information; and
receiving, from the UE, a third message for registration, the third message indicating the priority code.

2. The method according to claim 1, wherein
the third message indicates re-registration of the UE to the first core network.

3. The method according to claim 1, further comprising:
generating the priority code based on subscription information for the UE with a second core network node in the first core network.

4. The method according to claim 1, further comprising:
transmitting, to the UE, a fourth message in response to the third message, the fourth message indicating a rejection for the third message and a backoff time, wherein the backoff time is based on the priority code.

5. The method according to claim 1, wherein
the first message includes an identifier of a second core network to which the UE temporarily registered after the temporary deregistration of the UE from the first core network, and
the priority code is based on the identifier of the second core network.

6. The method according to claim 5, wherein
the third message includes third information indicating that the UE has returned from the second core network, and
the method further comprises
determining whether the priority code is valid based on the third information.

7. The method according to claim 1, wherein
the priority code is indicated with an expiration time of the priority code, and
the method further comprises
receiving, from the UE, a fifth message for registration, the fifth message not including the priority code in a case where the expiration time is expired.

8. The method according to claim 1, wherein
the first message is a deregistration request message,
the second message is deregistration accept message, and
the third message is registration request message.

9. The method according to claim 3, wherein
the first core network node in the first core network is an Access and Mobility Management Function (AMF) in a home network, and
the second core network node is a Unified Data Management (UDM).

10. A method of a user equipment (UE), the method comprising:
transmitting, to a first core network node in a first core network, a first message including first information indicating temporary deregistration of the UE from the first core network; and
receiving, from the first core network node, a second message including second information indicating a priority code for registration of the UE to the first core network, wherein the priority code is based on the first information.

11. The method according to claim 10, further comprising
transmitting, to the first core network node, a third message for registration, the third message indicating the priority code.

12. The method according to claim 11, wherein
the third message indicates re-registration of the UE to the first core network.

13. The method according to claim 10, wherein
the priority code is generated based on subscription information for the UE with a second core network node in the first core network.

14. The method according to claim 11, further comprising:
receiving, from the first core network, a fourth message in response to the third message, the fourth message indicating a rejection for the third message and a backoff time, wherein the backoff time is generated based on the priority code; and
transmitting, to the first core network node, a fifth message for registration after the backoff time has expired from the receipt of the fourth message.

15. The method according to claim 11, wherein
the first message includes an identifier of a second core network to which the UE temporarily registered after the temporary deregistration of the UE from the first core network, and
the priority code is based on the identifier of the second core network.

16. The method according to claim 15, wherein
the third message includes third information indicating that the UE has returned from the second core network, and
the priority code is checked based on the third information.

17. The method according to claim 10, wherein
the priority code is indicated with an expiration time of the priority code, and
the method further comprises
transmitting, to the first core network node, a fifth message for registration, the fifth message not including the priority code in a case where the expiration time is expired.

18. The method according to claim 11, wherein
the first message is a deregistration request message,
the second message is deregistration accept message, and
the third message is registration request message.

19. The method according to claim 13, wherein
the first core network node in the first core network is an Access and Mobility Management Function (AMF) in a home network, and
the second core network node is a Unified Data Management (UDM).

20. A first core network node in a first core network, the first core network node comprising:
a memory storing instructions; and
at least one hardware processor configured to process the instructions to:
receive, from a user equipment (UE), a first message including first information indicating temporary deregistration of the UE from the first core network;
transmit, to the UE, a second message including second information indicating a priority code for registration of the UE to the first core network, wherein the priority code is based on the first information; and
receive, from the UE, a third message for registration, the third message indicating the priority code.

21. (canceled)
